(19) United States
(12) Patent Application Publication
(10) Pub. No.: US 2024/0282314 A1
(43) Pub. Date: Aug. 22, 2024

(54) SYSTEMS AND METHODS FOR USING AUDIO WATERMARKS TO JOIN MEETINGS

(71) Applicant: Cisco Technology, Inc., San Jose, CA (US)

(72) Inventor: Keith Griffin, Oranmore (IE)

(21) Appl. No.: 18/112,157

(22) Filed: Feb. 21, 2023

(51) Int. Cl. G10L 17/22; G10L 17/06; G10L 19/018

(52) U.S. Cl. CPC G10L 17/22; G10L 17/06; G10L 19/018

(57) ABSTRACT

In one embodiment, a method includes generating an audio watermark for a user of a meeting session. The method also includes detecting the audio watermark. The audio watermark includes an identification of the user and an identification of the meeting session. The method further includes decoding the audio watermark and identifying the user and the meeting session in response to decoding the audio watermark.

### TECHNICAL FIELD

The present disclosure relates generally to communication networks, and more specifically to systems and methods for using audio watermarks to join meetings.

### BACKGROUND

Users may join meetings from different devices. For example, a user may join a meeting from a mobile phone on their commute to the office. As another example, the user may join a meeting from their desktop computer in their office. In certain situations, the user may join a meeting from their mobile phone on their commute to work and then re-join the same meeting once they arrive at their office. The process of joining the same meeting from different devices can be cumbersome.

### BRIEF DESCRIPTION OF THE DRAWINGS

FIG. 1 illustrates a system for using an audio watermark to join a meeting, in accordance with certain embodiments.

FIG. 2 illustrates a method for using a using an audio watermark to join a meeting, in accordance with certain embodiments.

FIG. 3 illustrates a computer system that may be used by the systems and methods described herein, in accordance with certain embodiments.

### DESCRIPTION OF EXAMPLE EMBODIMENTS

### Overview

According to an embodiment, a system includes one or more processors and one or more computer-readable non-transitory storage media coupled to the one or more processors and including instructions that, when executed by the one or more processors, cause the system to perform operations. The operations include generating an audio watermark for a user of a meeting session. The operations also include detecting the audio watermark. The operations further include decoding the audio watermark and identifying the user and the meeting session in response to decoding the audio watermark.

In accordance with certain embodiments, the watermark includes an identification of the user and an identification of the meeting session.

In accordance with some embodiments, detecting the audio watermark includes listening, via a microphone of a first device, for the audio watermark produced by a speaker of a second device.

In accordance with certain embodiments, the operations include moving, in response to identifying the user and the meeting session, the meeting session from a first device to a second device.

In accordance with some embodiments, the operations include initiating activation of a virtual assistant in response to identifying the user and the meeting session. In some embodiments, the operations include instructing the virtual assistant to perform an action associated with interacting with the user.

In accordance with certain embodiments, the operations include communicating a notification to a user. In certain embodiments, the operations include receiving an input from the user. In some embodiments, the operations include determining whether to move the meeting session from a first device to a second device based on the input from the user. In certain embodiments, the operations include interpreting the input from the user using one of the following: speech recognition or facial recognition.

According to another embodiment, a method includes generating an audio watermark for a user of a meeting session. The method also includes detecting the audio watermark. The method further includes decoding the audio watermark and identifying the user and the meeting session in response to decoding the audio watermark.

According to yet another embodiment, one or more computer-readable non-transitory storage media embody instructions that, when executed by a processor, cause the processor to perform operations. The operations include generating an audio watermark for a user of a meeting session. The operations also include detecting the audio watermark. The operations further include decoding the audio watermark and identifying the user and the meeting session in response to decoding the audio watermark.

Technical advantages of certain embodiments of this disclosure may include one or more of the following. This disclosure describes systems and methods for using audio watermarks to join meetings. Certain embodiments of this disclosure provide an assisted, fast, efficient, and secure way to move a meeting or call to from one device to another. In certain embodiments, audio watermarks are used to move meetings from one device to another with little to no user interaction. In some embodiments, a watermark detector is used to detect the audio watermark, which may be added to a wake word detector for applications that already include a wake word detector. Certain embodiments utilize a virtual assistant to assist the user in moving the meeting from one device to another, which provides a seamless experience for the user.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

This disclosure describes systems and methods for using audio watermarks to join meetings. A meeting participant may initially join a virtual meeting from a mobile device and then want to move the virtual meeting to a local device. For example, a meeting participant may join a virtual meeting from a smartphone on their commute to work and then want to move the virtual meeting to their desktop computer upon arriving to work. As another example, a meeting participant may join a virtual meeting on their laptop and then want to move the virtual meeting to a local device in a conference or meeting room. Certain embodiments of this disclosure provide an efficient way to seamlessly move a meeting or call to from one device to another.

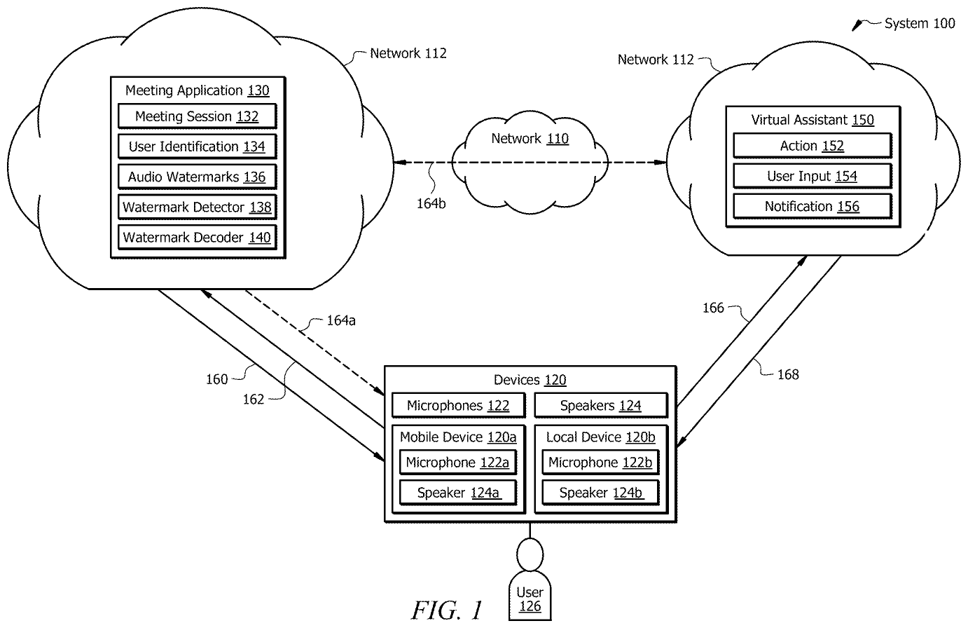

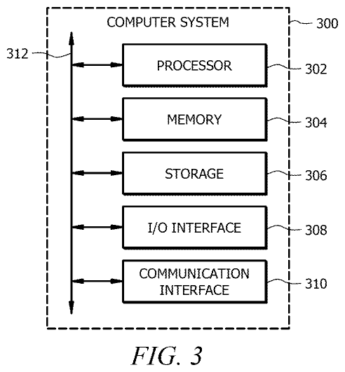

FIG. 1 illustrates a system 100 for using an audio watermark to join a meeting. System 100 or portions thereof may be associated with an entity, which may include any entity, such as a business, company, or enterprise, that uses watermarks to join meetings. In certain embodiments, the entity may be associated with a web conferencing organization, a telecommunications company, and the like. The components of system 100 may include any combination of hardware, firmware, and software. For example, the components of system 100 may use one or more elements of the computer system of FIG. 3.

In the illustrated embodiment of FIG. 1, system 100 includes a network 110, a cloud network 112, devices 120 (a mobile device 120a and a local device 120b), microphones 122 (a microphone 122a for mobile device 120a and a microphone 122b for local device 120b), speakers 124 (a speaker 124a for mobile device 120a and a speaker 124b for local device 120b), a user 126, a meeting application 130, a meeting session 132, a user identification 134, an audio watermark 136, a watermark detector 138, a watermark decoder 140, a virtual assistant 150, a notification 152, a user input 154, and an action 156.

Network 110 of system 100 is any type of network that facilitates communication between components of system 100. Network 110 may connect one or more components of system 100. One or more portions of network 110 may include an ad-hoc network, the Internet, an intranet, an extranet, a portion of the public switched telephone network (PSTN), a virtual private network (VPN), an Ethernet VPN (EVPN), a local area network (LAN), a wireless LAN (WLAN), a virtual LAN (VLAN), a wide area network (WAN), a wireless WAN (WWAN), a software-defined wide area network (SD-WAN), a metropolitan area network (MAN), a cellular telephone network, a Digital Subscriber Line (DSL), an Multiprotocol Label Switching (MPLS)network, a 3G/4G/5G network, a Long Term Evolution (LTE) network, a cloud network, a combination of two or more of these, or other suitable types of networks. Network 110 may include one or more different types of networks. Network 110 may be any communications network, such as a private network, a public network, a connection through the Internet, a mobile network, a Wi-Fi network, etc. One or more components of system 100 may communicate over network 110.

In the illustrated embodiment of FIG. 1, network 110 includes cloud network 112. Cloud network 112 is a WAN that hosts users and/or resources and facilitates communication between the users and/or resources via cloud-based technologies. In certain embodiments, cloud network 112 includes virtual routers, firewalls, network management software, etc. Cloud network 112 may distribute functions over multiple data centers. The underlying infrastructure for cloud network 112 may include servers, operating systems, storage, etc. Cloud network 112 may be a public cloud, a private cloud, or a hybrid (both public and private) cloud. In certain embodiments, cloud network 112 provides on-demand availability of computer system resources (e.g., data storage and computing power) without direct active management by user 126.

In certain embodiments, cloud network 112 includes one or more servers. Servers may include computer hardware and/or software (e.g., a computer program) that provide functionality for cloud network 112. For example, servers may communicate information to and/or receive information from meeting application 130. As another example, servers may communicate information to and/or receive information from virtual assistant 150. In certain embodiments, servers provide functionality (e.g., computations) for meeting application 130, watermark application 140, and virtual assistant 150.

Network 110 includes one or more nodes. Nodes are connection points within network 110 that receive, create, store and/or send data along a path. Nodes may include one or more redistribution points that recognize, process, and forward data to other nodes of network 110. Nodes may include virtual and/or physical nodes. For example, nodes may include one or more physical devices, virtual machines, bare metal servers, and the like. As another example, nodes may include data communications equipment such as computers, routers, servers, printers, workstations, switches, bridges, modems, hubs, and the like. In the illustrated embodiment of FIG. 1, nodes include the infrastructure for cloud network 112 and devices 120.

Devices 120 of system 100 represent electronic equipment that can receive, create, process, store, and/or communicate information. Devices 120 may include one or more components of the computer system of FIG. 3. In certain embodiments, devices 120 include electronic display screens. For example, devices 120 may include a liquid crystal display (LCD), an organic light-emitting diode (OLED) flat screen interface, and the like. Devices 120 include one or more input devices. Input devices include microphones 122, cameras, more touch screen components, digital buttons, digital keyboards, physical buttons, physical keyboards, graphical user interfaces (GUIs), etc. In the illustrated embodiment of FIG. 1, devices 120 include mobile device 120a and local device 120b.

Mobile device 120a represents an electronic device that can easily be moved from one location to another. Mobile device 120a may include a mobile phone (e.g., a smartphone), a laptop computer, a tablet, a personal digital assistant (PDAs), a wearable device (e.g., a smartwatch), etc. Mobile device 120a may use network 110 (e.g., a cellular, Bluetooth, or Wi-Fi network) to connect to a vehicular system or a headset. In certain embodiments, mobile device 120a may be powered by a battery (e.g., a lithium-ion battery). In some embodiments, mobile device 120a runs a mobile operating system that allows for the installation and/or operation of third-party applications (e.g., meeting application 130 and virtual assistant 150).

Local device 120b represents a stationary electronic device. Local device 120b may include a desktop computer, a personal computer, a workstation, a supercomputer, a mainframe computer, a minicomputer, a digital computer, and the like. Local device 120b may include one or more power supplies. In certain embodiments, local device 120b runs an operating system that allows the installation and operation of third-party applications (e.g., meeting application 130 and virtual assistant 150). Local device 120b may be located in any suitable location to receive and communicate information to user 126 of system 100. For example, local device 120b may be located in a booked or idle meeting room, a conference room, a huddle room, an office space, a residence, and the like.

In the illustrated embodiment of FIG. 1, devices 120 are associated with microphones 122. Microphones 122 of system 100 are input devices that capture audio by translating sound vibrations in the air into electronic signals. In certain embodiments, microphones 122 scribe the electronic signals to a recording medium. Microphones 122 may include analogue microphones, dynamic microphones, condenser microphones, microelectromechanical systems microphones, or any other suitable type of microphone 122. Microphones 122 may be built into devices 120 or connected to devices 120 via wired or wireless connections. In the illustrated embodiment of FIG. 1, microphones 122 include microphone 122a for mobile device 120a and microphone 122b for local device 120b.

In the illustrated embodiment of FIG. 1, devices 120 are associated with speakers 124. Speakers 124 of system 100 are output devices that produce sound. In certain embodiments, speakers 124 convert electrical energy into acoustical signal energy that is radiated into a room or open air. Speakers 124 may include electrodynamic speakers, loudspeakers, in-wall/ceiling speakers, soundbars, subwoofers, or any other suitable type of speaker 124. Speakers 124 may be built into devices 120 or connected to devices 120 via wired or wireless connections. In the illustrated embodiment of FIG. 1, speakers 124 include speaker 124a for mobile device 120a and speaker 124b for local device 120b.

User 126 of system 100 is a person who utilizes mobile device 120a and local device 120b. User 126 may be a local user, a remote user, a meeting participant, an administrator, a customer, a combination thereof, and the like. In certain embodiments, user 126 is associated with one or more accounts. User 126 may be associated with an account name, a username, a login name, a screen name, one or more passwords, a user profile, etc. In certain embodiments, user 126 utilizes one or more applications downloaded to mobile device 120. For example, user 126 may utilize meeting application 130 and/or virtual assistant application 150.

Devices 120 of system 100 run one or more applications. Applications are computer software packages that perform specific functions for user 126 or for another application. Each application may be self-contained or may be a group of programs. In the illustrated embodiment of FIG. 1, the applications running on devices 120 include meeting application 130 and virtual assistant application 150.

Meeting application 130 of system 100 is a software platform that facilitates communication with participants of a meeting. Meeting application 130 may be used to facilitate audio meetings, web conferences, video conferences, teleconferences, webinars, etc. In certain embodiments, meeting application 130 is installed on mobile device 120a and/or local device 120b. In some embodiments, meeting application runs via a web browser. Meeting application 130 may allow user 126 to speak and/or listen to audio over standard telephone lines, via microphones 122, via speakers 124, etc. Meeting application 130 may allow user 126 to visually interact with one or more other meeting participants via cameras (e.g., smartphone cameras, webcams, etc.). In the illustrated embodiment of FIG. 1, meeting application 130 performs one or more functions in cloud network 112.

In certain embodiments, meeting application 130 establishes meeting session 132. Meeting session 132 is a temporary and interactive information interchange between two or more devices 120 communicating over network 110. Meeting session 132 is established at a certain point in time, and then ended at a later point in time. In certain embodiments, one or more messages are exchanged during meeting session 132. Meeting session 132 may be established and/or implemented in accordance with one or more protocols (e.g., a Transmission Control Protocol/Internet Protocol (TCP/IP)) and/or services at the application layer, at the session layer, or at the transport layer in the Open Systems Interconnection (OSI) model. Meeting session 132 may include an application layer session (e.g., a Hypertext Transfer Protocol (HTTP) session or a telnet remote login session), a session layer session (e.g., a Session Initiation Protocol (SIP) based Internet phone call), a transport layer session (e.g., a TCP session), a server-side web session, a client-side web session, and the like.

User identification 134 is any identification used to uniquely identify user 126 of meeting session 132. User identification 134 may be a meeting attendee identification, a meeting participant identification, a user login credential (e.g., a login ID or password), an email address of user 126, a name of user 126, a social security number, a date of birth, an account number, a student record number, a driver's license number, an employee identification number, a photo, and the like. User identification 134 may include data that directly identifies user 126 or links user 126 to their identity. In certain embodiments, user identification 134 is used to bind device 120 to meeting session 132 for user 126.

In certain embodiments, meeting application 130 generates audio watermark 136 for user 126. Audio watermark 136 is a unique electronic identifier embedded in an audio signal. In certain embodiments, meeting application 130 embeds audio watermark 136 into an audio signal in a way that is difficult to remove. If the audio signal is copied, then the information is also carried in the copy. Each audio watermark 136 may include information such as an identification of meeting session 132, a unique identification of a meeting participant, a digital signature, personal information of user 126, and the like. For example, audio watermark 136 may include user identification 134 and an identification of meeting session 132. In certain embodiments, information may be embedded into audio as an inaudible watermark. The identification of meeting session 132 may be a meeting ID, a session ID, an event ID, and the like. The identification of meeting session 132 may include a session type (e.g., a breakout session or an innovation talk), a technology focus (e.g., an application, a cloud, or a collaboration), a session level (e.g., introductory, intermediate, or advanced), etc. The identification of meeting session 132 may include one or more numbers, letters, characters, a combination thereof, etc.

Meeting application 130 uses one or more techniques to generate audio watermark 136. The technique may depend on the desired data rate, audibility, and robustness of audio watermark 136. The techniques may include spread spectrum audio watermarking (SSW), ultrasound watermarking, spread spectrum watermarking, echo modulation watermarking, low frequency-based watermarking, time domain-based audio watermarking, audio watermarking in the frequency domain, audio watermarking in the compressed domain, a combination thereof, and the like. In certain embodiments, audio watermark 136 is repeatedly embedded throughout the audio content of meeting session 132.

Watermark detector 138 of system 100 is software used to determine whether audio watermark 136 is present in an audio signal. For example, watermark detector 138 may use one or more algorithms to detect the presence of audio watermark 136 in sound captured by microphone 122. In certain embodiments, watermark detector 138 is a hard decision detector that generates a binary output indicating that watermark 136 is detected or not detected. In some embodiments, watermark detector 138 is a soft decision detector that provides an output representing a value related to the detection reliability.

Watermark detector 138 may use any suitable technique to detect audio watermark 136. The techniques may include SSW, ultrasound watermarking, spread spectrum watermarking, echo modulation watermarking, low frequency-based watermarking, time domain-based audio watermarking, audio watermarking in the frequency domain, audio watermarking in the compressed domain, a combination thereof, and the like. In certain embodiments, watermark detector 138 may include a change to out-of-call behavior of microphone 122. In some embodiments, watermark detector 138 may use a short moving window technique similar to a wake word detector. In certain embodiments, watermark detector 138 may be added to a wake word detector for applications that already have a wake word detector.

Watermark decoder 140 of system 100 is software used to identify the information embedded in watermarks 136. In certain embodiments, watermark decoder 140 decodes the audio signal to extract the binary bit stream of data. In some embodiments, watermark decoder 140 performs decoding by synchronization. Watermark decoder 140 may use a key to modulate an embedded data sequence. In certain embodiments, watermark decoder 140 compares the decoded data to audio watermark 136. For example, watermark decoder 140 may compare a decoded sequence extracted from the audio signal to an original watermark sequence of audio watermark 136. In some embodiments, watermark decoder 140 uses the information (e.g., the identification of meeting session 132 and user identification 134) from decoded audio watermark 136 to identify user 126.

Virtual assistant 150 of system 100 is a software agent that performs tasks and/or services for user 126 based on user input 154. For example, virtual assistant 150 may assist user 126 with meeting joins, calls, and other functions. In certain embodiments, virtual assistant 150 is a cloud-based program that requires internet-connected devices and/or applications to function. Meeting application 130 may initiate activation of virtual assistant 150 in response to one or more occurrences. For example, meeting application 130 may initiate activation of virtual assistant 150 in response to identifying user 126 and meeting session 132 from audio watermark 136. In some embodiments, device 120 invokes virtual assistant 150 in proactive mode.

Upon activation, virtual assistant 150 may communicate notification 152 to user 126. Notification 152 is an alert generated by virtual assistant 150 to notify user 126 of a new message or update. Notification 152 may be an oral notification, a verbal notification, a text message, a desktop notification (e.g., a banner, sidebar, or badge notification), a push notification (e.g., a web, desktop, mobile app, or wearable device push notification), an email message, a vibrational notification, or any other suitable type of alert. In certain embodiments, virtual assistant 150 communicates notification 152 to user 126 suggesting that user 126 take a particular action 156. For example, virtual assistant 150 may communicate (orally or visually) the following notification 152 to user 126: “Hey <user's provided name>, would you like to move your meeting (or call) to the room device?”.

In certain embodiments, notification 152 requests input from user 126. For example, notification 152 may ask user 126 whether they would like virtual assistant 150 to move meeting session 132 from mobile device 120a to local device 120b. As another example, notification 152 may ask user 126 whether they would like to mute meeting session 132, end meeting session 132, resume meeting session 132, increase/decrease the volume on mobile device 120a and/or local device 120b, and the like.

User input 154 of system 100 is information or data communicated to a software program for processing. User input 154 may be communicated to one or more elements of system 100 via one or more of the following input devices: microphones 122 (audio input or voice input), speakers 124, a keyboard, a mouse, a webcam, a touchpad, a touch screen, a graphics tablet, etc. For example, user input 154 may be received from user 126 via microphone 122b of local device 120b. In certain embodiments, user 126 submits user input 154 in the form of a language request. For example, user input 154 may communicate the following statement to virtual assistant 150: “please move my meeting session to the device in my office.”

Virtual assistant 150 may interpret user input 154 using speech recognition, facial recognition, and the like. In certain embodiments, virtual assistant 150 understands natural language voice commands. For example, virtual assistant 150 may use natural language processing (NLP) to interpret “please move my meeting to the new device.” As another example, virtual assistant 150 may use NLP to interpret “please move my meeting to the new device in 5 minutes.” Virtual assistant 150 may process and/or store user input 154 in cloud network 112. In some embodiments, virtual assistant 150 may use one or more artificial intelligence (AI) platforms to interpret user input 154, to determine one or more actions 156, etc. Al platforms may include one or more machine learning platforms, NLP platforms, speech recognition platforms, a combination thereof, etc. In some embodiments, virtual assistant 150 uses one or more algorithms to learn from data received from user 126 and/or predict the needs of user 126.

Virtual assistant 150 may perform (or initiate performance of) action 156 in response to user input 154. Action 156 may include moving meeting session 132 from one device 120 to another, creating messages to communicate to one or more components of system 100, reading messages aloud, scheduling meetings, placing phone calls, reminding user 126 about appointments, and the like. In certain embodiments, virtual assistant 150 determines which (if any) action 156 to perform in response to user input 154. For example, virtual assistant 150 may receive user input 154 from user 126 indicating that user 126 would like to move their meeting session 132 from mobile device 120a to local device 120b. Virtual assistant 150 interprets user input 154 to determine associated action 156. Virtual assistant 150 may then instruct meeting application 130 to move meeting session 132 from one device 120 to another.

In operation, while driving to the office, user 126 uses meeting application 130 to join meeting session 132 from mobile device 120a. Meeting application 130 creates audio watermark 136 for user 126 of meeting session 132. Audio watermark 136 includes user identification 134 and an identification of meeting session 132. User 126 arrives to the office. As user 126 approaches local device 120b in office, microphone 122b of local device 120b receives (see notation 160) audio of meeting session 132 from speaker 124a of mobile device 120a. Local device 120b uses watermark detector 138 to detect (see notation 162) audio watermark 136 from the received audio. Once detected, local device 120b uses watermark decoder 140 to decode audio watermark 136. Local device 120b determines user identification 134 and the identification of meeting session 132 from the decoded information and uses this information to identify user 126 and meeting session 132. Once user 126 is identified, mobile device 120a may communicate (see notation 164a) meeting information associated with meeting session 132 to local device 120b.

In response to identifying user 126 and meeting session 132, local device 120b initiates (see notation 166) activation of virtual assistant 150. Virtual assistant 150 interacts (see notation 168) with user 126 by communicating notification 152 to user 126 and asking user 126 whether they would like to move meeting session 132 from mobile device 120a to local device 120b. User communicates user input 154 in the form of a verbal response to speaker 124b of local device 120b confirming that user 126 would like to move meeting session 132 to local device 120b. Virtual assistant 150 receives user input 154 from speaker 124b of local device 120b and uses speech recognition to interpret user input 154. In response to interpreting user input 154 confirming that user 126 would like to move meeting session 132 to local device 120b, virtual assistant 150 may instruct (see notation 164b) meeting application 130 to move meeting session 132 from mobile device 120a to mobile device 120b. As such, system 100 provides an assisted, fast, efficient, and secure process of moving meeting session 132 between devices 120 of user 126.

Although FIG. 1 illustrates a particular number of networks 110, cloud networks 112, devices 120, microphones 122, speakers 124, users 126, meeting applications 130, meeting sessions 132, user identifications 134, audio watermarks 136, watermark detectors 144, watermark decoders 146, virtual assistants 150, notifications 152, user inputs 154, and actions 156, this disclosure contemplates any suitable number of networks 110, cloud networks 112, devices 120, microphones 122, speakers 124, users 126, meeting applications 130, meeting sessions 132, user identifications 134, audio watermarks 136, watermark detectors 144, watermark decoders 146, virtual assistants 150, notifications 152, user inputs 154, and actions 156. For example, system 100 may include a plurality of users 126. As another example, meeting application 130 may create a plurality of audio watermarks 136 that uniquely identify each of the plurality of users 126.

Although FIG. 1 illustrates a particular arrangement of network 110, cloud network 112, devices 120 (mobile device 120a and local device 120b), microphones 122 (microphone 122a for mobile device 120a and microphone 122b for local device 120b), speakers 124 (speaker 124a for mobile device 120a and speaker 124b for local device 120b), user 126, meeting application 130, meeting session 132, user identification 134, audio watermark 136, watermark detector 138, watermark decoder 140, virtual assistant 150, notification 152, user input 154, and action 156, this disclosure contemplates any suitable arrangement of network 110, cloud network 112, devices 120 (mobile device 120a and local device 120b), microphones 122 (microphone 122a for mobile device 120a and microphone 122b for local device 120b), speakers 124 (speaker 124a for mobile device 120a and speaker 124b for local device 120b), user 126, meeting application 130, meeting session 132, user identification 134, audio watermark 136, watermark detector 138, watermark decoder 140, virtual assistant 150, notification 152, user input 154, and action 156. For example, meeting application 130 and/or virtual assistant 150 may be stored locally rather than in cloud network 112. As another example, meeting application 130 and virtual assistant 150 may be combined into one application.

Furthermore, although FIG. 1 describes and illustrates particular components, devices, or systems carrying out particular actions, this disclosure contemplates any suitable combination of any suitable components, devices, or systems carrying out any suitable actions.

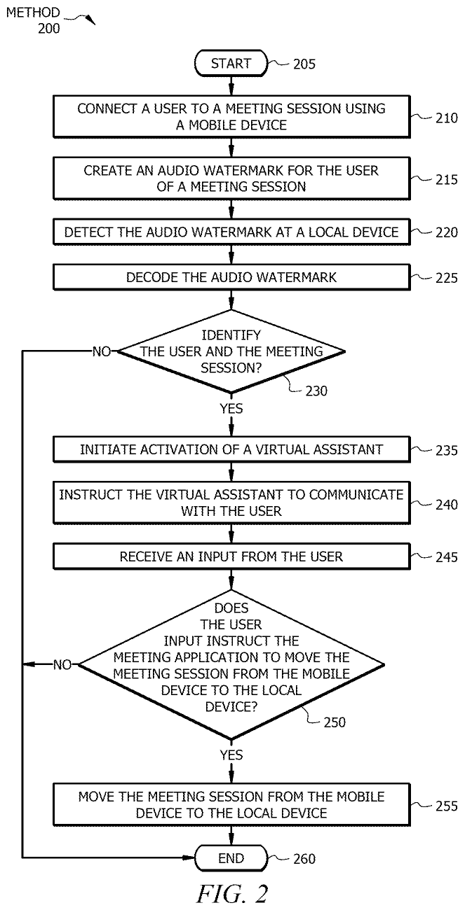

FIG. 2 illustrates a method 200 for using an audio watermark to join a meeting, in accordance with certain embodiments. Method 200 begins at step 205. At step 210 of method 200, a meeting application connects a user to a meeting session using a mobile device. For example, referring to FIG. 1, meeting application 130 may connect user 126 to meeting session 132 using mobile device 120a. The meeting session may be an audio session, a video session, a web conferencing session, and the like. The user may join the meeting session from their mobile device while commuting to work. Method 200 then moves from step 210 to step 215.

At step 215 of method 200, the meeting application creates an audio watermark for the user of the meeting session. For example, referring to FIG. 1, meeting application 130 may create audio watermark 136 for user 126 of meeting session 132. The audio watermark includes an identification of the user and an identification of the meeting session. The audio watermark may be repeatedly embedded throughout the audio content of the meeting session. Method 200 then moves from step 215 to step 220.

At step 220 of method 200, a local device detects the audio watermark. For example, referring to FIG. 1, local device 120b may use watermark detector 138 to detect audio watermark 136 by listening, via microphone 122b of local device 120b, for audio watermark 136 output by speaker 124a of mobile device 120a. In certain embodiments, the local device detects the audio watermark as the user and the mobile device move within proximity of the local device (e.g., the user enters their office). Method 200 then moves from step 215 to step 220.

At step 225 of method 200, the local device decodes the audio watermark. For example, referring to FIG. 1, local device 120b may use watermark decoder 140 to decode audio watermark 136 in response to detecting audio watermark 136. In certain embodiments, the meeting session determines a user identification and an identification of meeting session embedded in audio watermark 136. Method 200 then moves from step 225 to step 230.

At step 230 of method 200, the local device attempts to identify the user and the meeting session from the decoded audio watermark. For example, referring to FIG. 1, local device 120b may determine user identification 134 and an identification of meeting session 132 from the decoded information and use user identification 134 and the identification of meeting session 132 to identify user 126 of meeting session 132. If the local device fails to identify the user of the meeting session (e.g., the user identification and/or the identification of the meeting session are invalid or do not have a match), then method 200 advances from step 230 to step 260, where method 200 ends.

If, at step 230 of method 200, the local device identifies the user of the meeting session (e.g., the user identification and the identification of the meeting session), then method 200 moves from step 230 to step 235, where the local device initiates activation of a virtual assistant. For example, referring to FIG. 1, meeting session 132 may initiate activation of virtual assistant 150 in response to identifying user 126 and meeting session 132. Method 200 then moves from step 235 to step 240, where the local device instructs the virtual assistant to communicate with the user. For example, referring to FIG. 1, local device 120b may instruct virtual assistant 150 to interact with user 126. In certain embodiments, the meeting application communicates an oral or visual notification to the user. For example, the meeting application may ask the user whether they would like to move the meeting session to a different device. Method 200 then moves from step 240 to step 245.

At step 245 of method 200, the virtual assistant receives an input from the user. For example, referring to FIG. 1, virtual assistant 150 may receive user input 154 from user 126. The user input may be received by an input device such as a speaker, a touch screen, and the like. Method 200 then moves from step 245 to step 250, where the virtual assistant determines whether the user input has instructed the meeting application to move the meeting session from the mobile device to the local device. If the virtual assistant determines that the user input has not instructed the meeting application to move the meeting session from the mobile device to the local device, then method 200 advances from step 250 to step 260, where method 200 ends.

If, at step 250 of method 200, the virtual assistant determines that the user input has instructed the meeting application to move the meeting session from the mobile device to the local device, then method 200 moves from step 250 to step 255, where the virtual assistant instructs the meeting application to move the meeting session from the user's mobile device to the user's local device. Method 200 then moves from step 255 to step 260, where method 200 ends. As such, method 200 provides an assisted, fast, efficient, and secure process of using an audio watermark to move a meeting session between devices.

Although this disclosure describes and illustrates particular steps method 200 of FIG. 2 as occurring in a particular order, this disclosure contemplates any suitable steps of method 200 of FIG. 2 occurring in any suitable order. For example, the meeting session may create the watermark for the user prior to connecting the user to the meeting session.

Although this disclosure describes and illustrates an example method for using an audio watermark to join a meeting including the particular steps of the method of FIG. 2, this disclosure contemplates any suitable method for using an audio watermark to join a meeting including any suitable steps, which may include all, some, or none of the steps of the method of FIG. 2, where appropriate. For example, method 200 may determine whether the user has instructed the meeting application to move the meeting from a local device to a mobile device in addition to (or in lieu of) steps 250 and 255.

Furthermore, although FIG. 2 describes and illustrates particular components, devices, or systems carrying out particular actions, this disclosure contemplates any suitable combination of any suitable components, devices, or systems carrying out any suitable actions.

FIG. 3 illustrates an example computer system 300. In particular embodiments, one or more computer system 300 perform one or more steps of one or more methods described or illustrated herein. In particular embodiments, one or more computer system 300 provide functionality described or illustrated herein. In particular embodiments, software running on one or more computer system 300 performs one or more steps of one or more methods described or illustrated herein or provides functionality described or illustrated herein. Particular embodiments include one or more portions of one or more computer system 300. Herein, reference to a computer system may encompass a computing device, and vice versa, where appropriate. Moreover, reference to a computer system may encompass one or more computer systems, where appropriate.

This disclosure contemplates any suitable number of computer system 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 300 may include one or more computer system 300; be unitary or distributed; span multiple locations; span multiple machines; span multiple data centers; or reside in a cloud, which may include one or more cloud components in one or more networks. Where appropriate, one or more computer system 300 may perform without substantial spatial or temporal limitation one or more steps of one or more methods described or illustrated herein. As an example and not by way of limitation, one or more computer system 300 may perform in real time or in batch mode one or more steps of one or more methods described or illustrated herein. One or more computer system 300 may perform at different times or at different locations one or more steps of one or more methods described or illustrated herein, where appropriate.

In particular embodiments, computer system 300 includes a processor 302, processor 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, processor 304, or storage 306; decode and execute them; and then write one or more results to an internal register, an internal cache, processor 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in processor 304 or storage 306, and the instruction caches may speed up retrieval of those instructions by processor 302. Data in the data caches may be copies of data in processor 304 or storage 306 for instructions executing at processor 302 to operate on; the results of previous instructions executed at processor 302 for access by subsequent instructions executing at processor 302 or for writing to processor 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, processor 304 includes main memory for storing instructions for processor 302 to execute or data for processor 302 to operate on. As an example and not by way of limitation, computer system 300 may load instructions from storage 306 or another source (such as, for example, another computer system 300) to processor 304. Processor 302 may then load the instructions from processor 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to processor 304. In particular embodiments, processor 302 executes only instructions in one or more internal registers or internal caches or in processor 304 (as opposed to storage 306 or elsewhere) and operates only on data in one or more internal registers or internal caches or in processor 304 (as opposed to storage 306 or elsewhere). One or more memory buses (which may each include an address bus and a data bus) may couple processor 302 to processor 304. Bus 312 may include one or more memory buses, as described below. In particular embodiments, one or more memory management units (MMUs) reside between processor 302 and processor 304 and facilitate accesses to processor 304 requested by processor 302. In particular embodiments, processor 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Processor 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer system 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 310 for it. As an example and not by way of limitation, computer system 300 may communicate with an ad hoc network, a personal area network (PAN), a LAN, a WAN, a MAN, or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a Wi-Fi network, a WI-MAX network, a cellular telephone network (such as, for example, a Global System for Mobile Communications (GSM) network, a 3G network, a 4G network, a 5G network, an LTE network, or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A system, comprising:
one or more processors; and
one or more computer-readable non-transitory storage media coupled to the one or more processors and comprising instructions that, when executed by the one or more processors, cause the system to perform operations comprising:
generating an audio watermark for a user of a meeting session;
detecting the audio watermark;
decoding the audio watermark; and
identifying the user and the meeting session in response to decoding the audio watermark.

2. The system of claim 1, wherein the watermark comprises:
an identification of the user; and
an identification of the meeting session.

3. The system of claim 1, wherein detecting the audio watermark comprises listening, via a microphone of a first device, for the audio watermark produced by a speaker of a second device.

4. The system of claim 1, the operations further comprising moving, in response to identifying the user and the meeting session, the meeting session from a first device to a second device.

5. The system of claim 1, the operations further comprising:
initiating activation of a virtual assistant in response to identifying the user and the meeting session; and
instructing the virtual assistant to perform an action associated with interacting with the user.

6. The system of claim 1, the operations further comprising:
communicating a notification to a user;
receiving an input from the user; and
determining whether to move the meeting session from a first device to a second device based on the input from the user.

7. The system of claim 6, the operations further comprising interpreting the input from the user using one of the following:
speech recognition; or
facial recognition.

8. A method, comprising:
generating an audio watermark for a user of a meeting session;
detecting the audio watermark;
decoding the audio watermark; and
identifying the user and the meeting session in response to decoding the audio watermark.

9. The method of claim 8, wherein the watermark comprises:
an identification of the user; and
an identification of the meeting session.

10. The method of claim 8, wherein detecting the audio watermark comprises listening, via a microphone of a first device, for the audio watermark produced by a speaker of a second device.

11. The method of claim 8, further comprising moving, in response to identifying the user and the meeting session, the meeting session from a first device to a second device.

12. The method of claim 8, further comprising:
initiating activation of a virtual assistant in response to identifying the user and the meeting session; and
instructing the virtual assistant to perform an action associated with interacting with the user.

13. The method of claim 8, further comprising:
communicating a notification to a user;
receiving an input from the user; and
determining whether to move the meeting session from a first device to a second device based on the input from the user.

14. The method of claim 8, further comprising interpreting the input from the user using one of the following:
speech recognition; or
facial recognition.

15. One or more computer-readable non-transitory storage media embodying instructions that, when executed by a processor, cause the processor to perform operations comprising:
generating an audio watermark for a user of a meeting session;
detecting the audio watermark;
decoding the audio watermark; and
identifying the user and the meeting session in response to decoding the audio watermark.

16. The one or more computer-readable non-transitory storage media of claim 15, wherein the watermark comprises:
an identification of the user; and
an identification of the meeting session.

17. The one or more computer-readable non-transitory storage media of claim 15, wherein detecting the audio watermark comprises listening, via a microphone of a first device, for the audio watermark produced by a speaker of a second device.

18. The one or more computer-readable non-transitory storage media of claim 15, the operations further comprising moving, in response to identifying the user and the meeting session, the meeting session from a first device to a second device.

19. The one or more computer-readable non-transitory storage media of claim 15, the operations further comprising:
initiating activation of a virtual assistant in response to identifying the user and the meeting session; and
instructing the virtual assistant to perform an action associated with interacting with the user.

20. The one or more computer-readable non-transitory storage media of claim 15, the operations further comprising:
communicating a notification to a user;
receiving an input from the user; and
determining whether to move the meeting session from a first device to a second device based on the input from the user.
